(19) United States
(12) Patent Application Publication
(10) Pub. No.: US 2026/0236504 A1
(43) Pub. Date: Aug. 13, 2026

(54) EDGE ARTIFICIAL INTELLIGENCE SYSTEM AND CONTEXT MANAGEMENT METHOD THEREOF

(71) Applicant: REALTEK SEMICONDUCTOR CORP., HsinChu (TW)

(72) Inventor: Kai-Hsiang Chou, HsinChu (TW)

(73) Assignee: REALTEK SEMICONDUCTOR CORP., HsinChu (TW)

(21) Appl. No.: 19/339,583

(22) Filed: Sep. 25, 2025

(30) Foreign Application Priority Data
Feb. 7, 2025 (TW) 114104698

(51) Int. Cl. G06F 16/3329; G06F 16/353

(52) U.S. Cl. CPC G06F 16/33295; G06F 16/353

(57) ABSTRACT

A context management method of an edge artificial intelligence system includes: receiving a user question, appending an auxiliary information thereto to generate a current question, and storing it in a conversation history record using a mixer module; receiving the conversation history record, using a small LLM to classify the conversation history record into topic categories, and determining a topic category among the at least one topic category to which the current question belongs using a classifier module; and sorting history questions and history responses within the topic category to which the current question belongs in accordance with a similarity between the history questions and the current question and a similarity between the history responses and the current question to generate a prompt output sequence for the topic category to which the current question belongs and sending the prompt output sequence to an external LLM using a sorter module.

### CROSS-REFERENCE TO RELATED APPLICATION

This non-provisional application claims priority under 35 U.S.C. § 119(a) to Patent Application No. 114104698 filed in Taiwan, R.O.C. on Feb. 7, 2025, the entire contents of which are hereby incorporated by reference.

### BACKGROUND

### Technical Field

The instant disclosure relates to context management method of an edge artificial intelligence system, in particular to a method using an edge artificial intelligence system to sort a conversation history record.

### Related Art

Currently, more commonly used large language models include Copilot, ChatGPT 4, and Claude 3.5. Context management methods of these large language models have their own unique characteristics.

The context management method of Copilot first considers the most recent interaction as a conversation history record increases to ensure the relevance of the response. In addition, the number of tokens (i.e., the smallest unit of text) which Copilot is able to process is limited. The limitation on token number directly affects a context capacity of the conversation. Once the limitation is exceeded, earlier tokens will be discarded so that the newest content can be processed.

The context management method of ChatGPT-4 defines, through a fixed context window, the maximum text amount which can be processed. ChatGPT-4 performs computation with tokens as the basis. When the input exceeds the context window, the earliest tokens will be discarded, and merely the newest tokens are kept, so that ChatGPT-4 can focus on processing the newest content. In addition, ChatGPT-4 is able to associate each token to other tokens which are inputted and determine which tokens are the most important to the generation of the response to the current question in accordance with an attention weight. This method processes key content through attention mechanism and is able to ignore unrelated portions even at the presence of a large amount of context. ChatGPT-4 essentially merely has a short-term memory and is merely able to generate responses in accordance with the context provided by the current interaction. As the conversation progresses, the short-term memory will be updated continuously, and earlier contents will be gradually forgotten. Once the limitation of the context window is exceeded, earlier important information may be lost, and the accuracy of the response may be affected. In addition, the errors in the early responses may also extend to later conversations. Therefore, errors may repeatedly accumulate.

The context management method of Claude 3.5 is able to analyze the context of the current conversation to determine whether the current conversation topic still matches the interest of the user. When the interest of the user in the current conversation topic is determined to have decreased or when the direction of the question is changed, the context management method of Claude 3.5 may recommend switching the conversation topic to maintain the fluidity of the conversation. In addition, when a new conversation topic is determined to better match the interest of the user, a new conversation topic may be voluntarily introduced. Claude 3.5 is able to dynamically adjust the conversation strategy based on the algorithm to ensure the content is both relevant and interesting.

Regarding the aspect of context management, currently known large language models have the following problems: 1. The limitation of token number: ChatGPT-4, Copilot, and some large language models are limited by the token number when processing inputs. Since the operation of large language models need very high computation resources, the token capacity cannot be easily expanded. In addition, these large language models count both the questions of the user and the responses of the large language models towards the token numbers, therefore an effective token number which the user may use is decreased, and thus resources are wasted. 2. The influence of conversation history record: when the conversation history record is too long, the large language models usually recommend the user switch topic and warn the user that the models will forget previous conversation history record. Different large language models adopt different strategies when processing overly long conversation history record. For example, because ChatGPT-4 responses in-detail, the conversation history record exceeds the capacity of the context window fairly fast; while Copilot forcefully initiates a new conversation after replying about 30 questions or reaching a certain time.

Because of the influence of the attention mechanism and the limitation of merely having short-term memory, the response accuracy of large language models may be affected. For example, when the user asks Copilot: “How many questions have I asked?” Copilot correctly responses: “3 questions.” Immediately after, if two further questions which are obviously different from the previous 3 questions are asked, and then the same question is asked again: “How many questions have I asked?” Copilot will response with the previous answer “3 questions” instead of updating the answer as “5 questions.” In one aspect, the large language models usually process the context through the attention mechanism. In some scenarios, the large language models overly depend on previous responses, erroneously consider that the previous responses are still effective, and are unable to accurately update the count. In another aspect, the memories of the large language models are limited to the context window of the current conversation and cannot track all the details in the entire conversation history record. Therefore, the large language models are merely able to respond in accordance with “seeable” content and cannot accumulate previous question number. In addition, some large language models, such as ChatGPT-4 and Copilot, may overly rush to forget questions not related to the current topic. Therefore, information is lost, and conversation is inconsistent. On the other hand, some large language models, such as Claude 3.5, merely memorize relevant content of the last conversation topic and completely ignore previous discussions. Although such strategy is able to lower the computation burden, such strategy may result in context lost and affect the accuracy of the response. Therefore, how to more effectively manage the usage of the tokens, avoid unnecessary computation burden, and at the same time maintain the relevance and consistency of the conversation is one of the key directions for the continuous improvement of large language models.

### SUMMARY

ChatGPT-4 and Copilot depend on complete conversation history record to perform attention computation, while Claude 3.5 completely depends on the last one conversation topic. Therefore, a balance point should be achieved, where the entire conversation history record is kept, and to which topic category the current question belongs is determined. Then, the conversation history record of the topic category to which the current question belongs is taken as a prompt provided for the large language model. The other portion of the conversation history record may be stored in a local memory and does not need to be directly used for the current computation. This manner is able to not only avoid overly depending on the entire conversation history record but also increase computation efficiency and decrease unnecessary computation burden.

As the numbers of input tokens of large language models continuously increase, multiple questions may be computed as the same sentence. This may result in the lack of concept of time sequence. In order to avoid such situation, the text of each question may be appended with a timestamp or a sequence ID. This is helpful for effective differentiation of different questions, avoiding quoting wrong information, and preventing the situation where errors are repeatedly accumulated. In addition, this method is also able to solve problems in which some large language models cannot understand time zones or lack consciousness of time.

One or some embodiments of the instant disclosure provide an edge artificial intelligence system comprising a mixer module, a classifier module, and a sorter module. The mixer module is configured to receive a user question, to append auxiliary information to the user question to generate a current question, and to store the current question in a conversation history record. The classifier module is configured to receive the conversation history record, to use a small large language model (small LLM) to classify the conversation history record into at least one topic category, and to determine a topic category among the at least one topic category to which the current question belongs. The sorter module is configured to sort at least one history question and at least one history response within the topic category to which the current question belongs in accordance with a similarity between the at least one history question and the current question and a similarity between the at least one history response and the current question to generate a prompt output sequence for the topic category to which the current question belongs and to send the prompt output sequence to an external large language model (external LLM).

One or some embodiments of the instant disclosure provide a context management method of an edge artificial intelligence system. The context management method comprises: receiving a user question, appending an auxiliary information to the user question to generate a current question, and storing the current question in a conversation history record by using a mixer module; receiving the conversation history record, using a small LLM to classify the conversation history record into at least one topic category, and determining a topic category among the at least one topic category to which the current question belongs by using a classifier module; and sorting at least one history question and at least one history response within the topic category to which the current question belongs in accordance with a similarity between the at least one history question and the current question and a similarity between the at least one history response and the current question to generate a prompt output sequence for the topic category to which the current question belongs and sending the prompt output sequence to an external LLM by using a sorter module.

### BRIEF DESCRIPTION OF THE DRAWINGS

The instant disclosure will become more fully understood from the detailed description given herein below for illustration only, and therefore not limitative of the instant disclosure, wherein:

FIG. 1 illustrates a block diagram of a first embodiment of an edge artificial intelligence system according to an embodiment of the instant disclosure;

FIG. 2 illustrates a block diagram of a second embodiment of an edge artificial intelligence system according to an embodiment of the instant disclosure;

FIG. 3 illustrates a schematic diagram of a sorting method of a sorter module of an edge artificial intelligence system according to an embodiment of the instant disclosure; and

FIG. 4 illustrates a flow chart of a context management method of an edge artificial intelligence system according to an embodiment of the instant disclosure.

### DETAILED DESCRIPTION

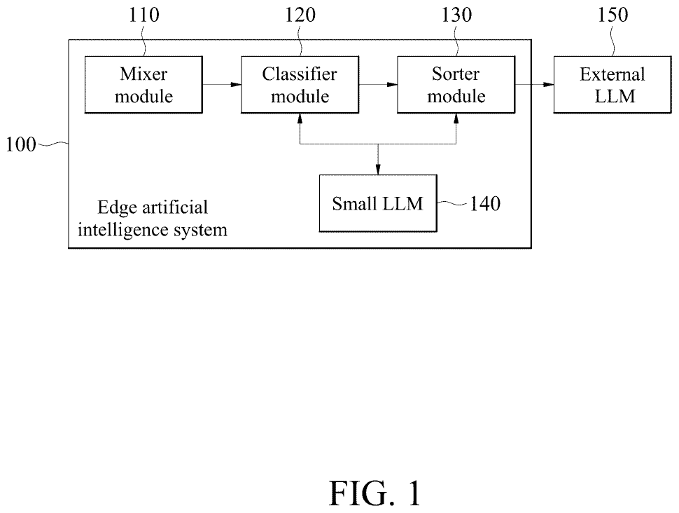

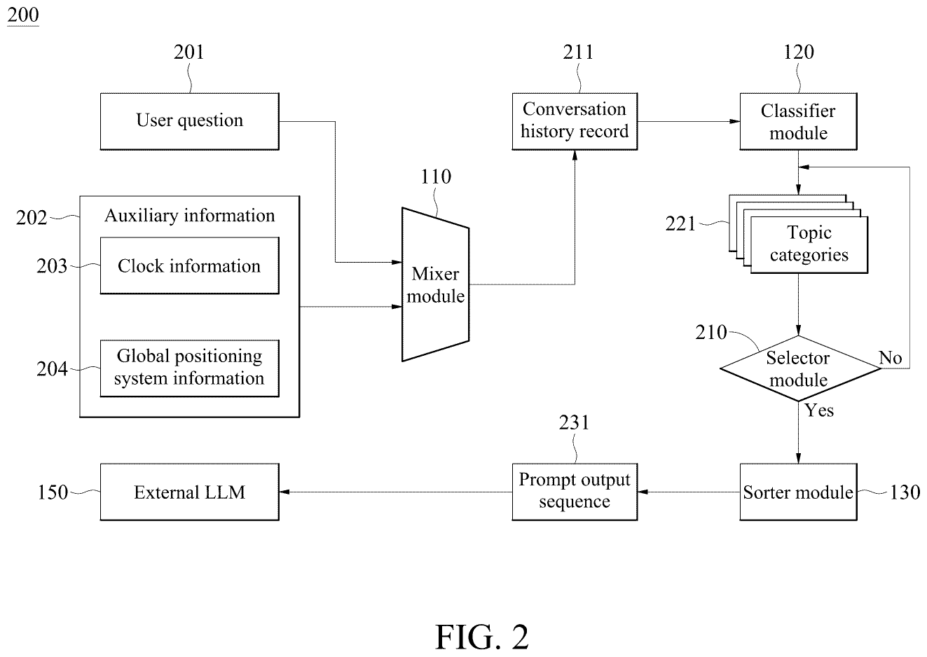

FIG. 1 illustrates a block diagram of a first embodiment of an edge artificial intelligence system 100 according to an embodiment of the instant disclosure. FIG. 2 illustrates a block diagram of a second embodiment of an edge artificial intelligence system 200 according to an embodiment of the instant disclosure. Please refer to FIG. 1 and FIG. 2 for the following description.

In the embodiment shown in FIG. 1, the edge artificial intelligence system 100 comprises a mixer module 110, a classifier module 120, and a sorter module 130. The mixer module 110 is configured to receive a user question 201, to append auxiliary information 202 to the user question 201 to generate a current question (a latest user question 201 which comprises the auxiliary information 202), and to store the current question in a conversation history record 211. The classifier module 120 is configured to receive the conversation history record 211, to use a small LLM 140 to classify the conversation history record 211 into at least one topic category 211, and to determine a topic category 211 among the at least one topic category 211 to which the current question belongs. The sorter module 130 is configured to sort at least one history question and at least one history response within the topic category 221 to which the current question belongs in accordance with a similarity between the at least one history question and the current question and a similarity between the at least one history response and the current question to generate a prompt output sequence 231 for the topic category 221 to which the current question belongs, and the sorter module 130 is configured to send the prompt output sequence 231 to an external LLM 150. The conversation history record 211 comprises the history question and the history response. The history question is a question which has been asked by the user before the current question is generated. The history response is a response generated by the external LLM 150 in accordance with a corresponding history question. The history question and the history response are stored in the memory and become a part of the conversation history record 211.

In an embodiment, the edge artificial intelligence system 100 may be applied to an edge artificial intelligence device. The edge artificial intelligence device may be a smart wearable device, a smart mobile device, a personal computer, a notebook computer, or a server. The edge artificial intelligence device comprises a computation unit (such as: a central processor) and a memory unit (such as: a random access memory or a non-volatile memory element). The edge artificial intelligence device implements the functional operations of the mixer module 110, the classifier module 120, and the sorter module 130 in the edge artificial intelligence system 100 through the computation unit. The memory unit of the edge artificial intelligence device is configured to store the conversation history record 211. In addition, the edge artificial intelligence system 100 comprises a small LLM 140. The small LLM 140 is a lightweight large language model version having fewer parameters, and the small LLM 140 is designed to be operable effectively on a single GPU or hardware with lower performance. In comparison with large-scale large language models (such as: GPT-4, PaLM), the small LLM 140 focuses more on implementing specific application goals while maintaining the core abilities of language understanding, generation, and inference at the same time. The classifier module 120 uses the small LLM 140 to determine the topic category 221 to which the current question belongs. The sorter module 130 uses the small LLM 140 to sort the history questions and the history responses in the topic category 221 to which the current question belongs. In an embodiment, the small LLM 140 may be arranged in the classifier module 120.

In the embodiment shown in FIG. 2, the edge artificial intelligence system 200 comprises a mixer module 110, a classifier module 120, a selector module 210, and a sorter module 130.

In the embodiment shown in FIG. 2, the mixer module 110 of the edge artificial intelligence system 200 is configured to receive the user question 201, to append auxiliary information 202 to the user question 201 to generate a current question (a latest user question 201 which comprises the auxiliary information 202). In addition, the edge artificial intelligence system 200 is able to generate the auxiliary information 202 through the edge artificial intelligence device; for example, the edge artificial intelligence system 200 may use a clock of the edge artificial intelligence device to generate clock information 203 for the mixer module 110 and use a global positioning system (GPS) of the edge artificial intelligence device to generate global positioning system information 204 for the mixer module 110. The mixer module 110 is able to append the clock information 203 and the global positioning system information 204 to the user question 201. In addition, the mixer module 110 is able to append a sequence ID to the user question 201 to generate the current question. Therefore, the auxiliary information 202 may comprise time information, time zone information, the clock information 203, the global positioning system information 204, and/or the sequence ID. A format of the current question may be, for example, “2024 Sep. 12 14:56(UTC+8 ) How many questions have I asked?” In addition, the mixer module 110 stores the current question in the conversation history record 211 so as to identify an order of each of the history questions from the conversation history record 211.

In an embodiment, the edge artificial intelligence system 200 is able to store the conversation history record 211 in a random access memory (RAM) of the edge artificial intelligence device and allocate a region in the memory to store the conversation history record 211. In addition to the current question, the conversation history record 211 further comprises the history questions and the history responses. The history questions are questions which have been asked by the user before the current question is generated, and the history questions have been appended with the auxiliary information 202 and stored in the memory and become a part of the conversation history record 211. The history responses are response contents generated by the external LLM 150 after the external LLM 150 performs inference in accordance with corresponding history questions, and the history responses have also been appended with the auxiliary information 202 and stored in the memory and become a part of the conversation history record 211. In an embodiment, the edge artificial intelligence system 200 may also store the conversation history record 211 in a non-volatile memory element (such as a hard drive or a flash memory) of the edge artificial intelligence device.

In the embodiment shown in FIG. 2, the classifier module 120 of the edge artificial intelligence system 200 is configured to receive the receive conversation history record 211, to use the small LLM 140 to classify the conversation history record 211 in order to classify the conversation history record 211 into at least one topic category 221, and to determine the topic category 221 to which the current question belongs. In an embodiment, the classifier module 120 is arranged with a tokenizer. The tokenizer is configured to divide the current questions and the history questions in the conversation history record 211 into a plurality of tokens for the small LLM 140 to process. In another embodiment, the classifier module 120 is not arranged with the tokenizer, and the tokenizer is arranged in the small LLM 140 to perform preceding processing on the conversation history record 211.

In an embodiment, the classifier module 120 comprises a small LLM 140. The classifier module 120 uses the small LLM 140 to determine the topic category 221 to which the current question belongs. The small LLM 140 consists of an embedding layer, a transformer layer, and a classification head layer. The embedding layer is configured to convert the tokens divided from the current question in the conversation history record 211 into embedding vectors. The transformer layer is configured to process the embedding vectors to generate a contextual meaning representation of the current question. The classification head layer is configured to determine the topic category 221 to which the current question belongs in accordance with the contextual meaning representation of the current question.

In an embodiment, the classifier module 120 computes meaning similarities between the current question and the history questions in a one-by-one manner. The classifier module 120 uses the small LLM 140 to convert the current question and all history questions into vector representations, and the classifier module 120 uses the small LLM 140 to measure the meaning similarity between the current question and each history question in accordance with the vector distance between the current question and each history question. Commonly used measuring methods for the similarities are for example: cosine similarity or Euclidean distance. The cosine similarity measures the similarity through calculating an angle between two vectors, wherein the value ranges from 1 (indicating that the vector distance is smaller) to −1 (indicating that the vector distance is larger). When the cosine similarity is close to 1, it means that the meanings of the two questions are very similar. When the cosine similarity is close to 0, it means that the difference between the meanings of the two questions is larger. When the cosine similarity is close to −1, it means that the meanings of the two questions are almost completely opposite to each other. The Euclidean distance measures the distance between two vectors in the space in another manner. When the Euclidean distance is smaller (indicating that the vector distance is smaller), it means that a difference between the meanings of the two questions is smaller. When the Euclidean distance is larger (indicating that the vector distance is larger), it means that a difference between the meanings of the two questions is larger.

In an embodiment, the classifier module 120 performs clustering on the history questions and uses a clustering algorithm (such as K-means or layer clustering) to perform classification on each history question in the conversation history record 211 to classify at least one topic category 221 and determines a boundary of each topic category 221. In order to evaluate the similarity between the current question and each topic category 221, the vector distance between the vector of the current question and a center vector of each topic category 221 is calculated to obtain the similarity between the current question and each topic category 221. The center vector of the topic category 221 is defined as a vector average value of all history questions in the topic category 221. In addition, the classifier module 120 may be arranged with a threshold value (for example, 0.8). If the similarity between the current question and a certain topic category 221 exceeds the threshold value, the current question and the certain topic category 221 are considered to be similar, and the current question is classified as the certain topic category 221. On the contrary, if the similarity between the current question and each topic category 221 is less than the threshold value, the current question and any existing topic category 221 are considered to be not similar. Under such situation, the classifier module 120 may create a new topic category 221 and takes the current question as a first question in the new topic category 221.

In the embodiment shown in FIG. 2, the selector module 210 of the edge artificial intelligence system 200 is configured to select the topic category 221 comprising the current question to output all history questions and all history responses in the topic category 221 to which the current question belongs. In an embodiment, the selector module 210 determines whether the topic category 221 comprises the current question. When the selector module 210 determines that a certain topic category 221 comprises the current question, all history questions and all history responses in the certain topic category 221 are output to the sorter module 130. When the selector module 210 determines that a topic category 221 does not comprise the current question, the selector module 210 performs the determination on the next topic category 221.

In the embodiment shown in FIG. 2, the sorter module 130 of the edge artificial intelligence system 200 is configured to receive the history questions and the history responses in the topic category 221 to which the current question belongs, to arrange an order of the history questions and the history responses in the topic category 221 to which the current question belongs in accordance with the similarities between the current question and the history questions and the similarities between the current question and the history responses, to generate the prompt output sequence 231 of the topic category 221 to which the current question belongs, and to send the prompt output sequence 231 to the external LLM 150. In an embodiment, the sorter module 130 performs arrangement in accordance with the meaning similarities between the current question and the history questions and the meaning similarities between the current question and the history responses. In response to that the sorting module 130 determines that the similarity between the current question and a history question is higher and that the similarity between the current question and a history response is higher, the history question and the history response are arranged at positions closer to the current question in the prompt output sequence 231. In response to that the sorting module 130 determines that the similarity between the current question and a history question is lower and that the similarity between the current question and a history response is lower, the history question and the history response are arranged at positions farther away from the current question in the prompt output sequence 231. In response to that the sorting module 130 determines that the similarity between the current question and a history question is 100% or substantially the same and that the similarity between the current question and a history response is 100% or substantially the same, the history question and the history response are not arranged in the prompt output sequence 231. In an embodiment, in response to that the sorting module 130 determines that the similarity between the current question and a history question is 100% or substantially the same, the history question and the history responses corresponding to the history question are not arranged in the prompt output sequence 231.

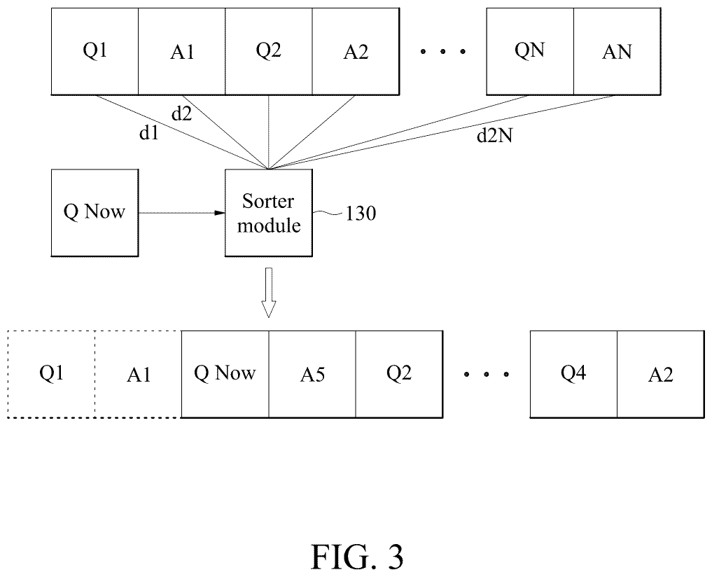

Please refer to FIG. 3. FIG. 3 illustrates a schematic diagram of a sorting method of a sorter module 130 of an edge artificial intelligence system 100 according to an embodiment of the instant disclosure. In the embodiment shown in FIG. 3, the sorter module 130 may comprise an input data structure and an output data structure. The input data structure is configured to store history questions (Q1, Q2, . . . , QN) and history responses (A1, A2, . . . , AN) in the topic category 221 to which the current question (QNow) (which is received from the selector module 210) belongs. The input data structure is configured to store the history questions (Q1, Q2, . . . , QN) and the history responses (A1, A2, . . . , AN) sorted by the sorter module 130. Data in the input data structure which have not been processed by the sorter module 130 may be arranged in accordance with generation times of the history questions (Q1, Q2, . . . , QN) and the history response (A1, A2, . . . , AN) or arranged in accordance with another rule; for example, the history questions and the history responses may be arranged as Q1, A1, Q2, A2 . . . QN, AN. The sorter module 130 performs sorting in accordance with the vector distances between the current question (QNow) and the history questions (Q1, Q2, . . . , QN) and the vector distances between the current question (QNow) and the history responses. The vector distances are values calculated in accordance with cosine similarity or Euclidean distance. As shown in FIG. 3, the vector distance between the current question (QNow) and the history question (Q1) is d1; the vector distance between the current question (QNow) and the history response (A1) is d2; and so on; and the vector distance between the current question (QNow) and the history response (AN) is d2N. The sorter module 130 arranges the order of the history questions (Q1, Q2, . . . , QN) and the history responses (A1, A2, . . . , AN) in the topic category 221 to which the current question (QNow) belongs in accordance with the values of the vector distances (d1, d2 . . . d2N) to generate a sorting result. The sorter module 130 stores the sorting result (such as: Q1, A1, QNOW, A5, Q2 . . . Q4, A2) to the output data structure.

In an embodiment, the sorter module 130 normalizes the vector distances to a range of [0,1] to obtain the similarities between the current question (QNow) and the history questions (Q1, Q2, . . . , QN) and obtain the similarities between the current question (QNow) and the history responses (A1, A2, . . . , AN). The sorter module 130 determines whether the similarities between the current question (QNow) and the history questions (Q1, Q2, . . . , QN) are 100% or substantially the same and determines whether the similarities between the current question (QNow) and the history responses (A1, A2, . . . , AN) are 100% or substantially the same in accordance with the similarities between the current question (QNow) and the history questions (Q1, Q2, . . . , QN) and in accordance with the similarities between the current question (QNow) and the history responses (A1, A2, . . . , AN). When the sorter module 130 determines that the similarity between the current question (QNow) and a history question (such as: Q1) is 100% or substantially the same, and when the sorter module 130 determines that the similarity between the current question (QNow) and a history response (such as: A1) is 100% or substantially the same, the history question (such as: Q1) and the history response (such as: A1) are removed from the output data structure of the sorter module 130, or the history question (such as: Q1) and the history response (such as: A1) are not stored to the output data structure of the sorter module 130. Then, the sorter module 130 outputs the sorting result from the output data structure to the prompt output sequence 231 so as to send the sorting result to the external LLM 150. Now, the data in the prompt output sequence 231 are QNOW, A5, Q2 . . . Q4, A2 and do not contain Q1 and A1.

In an embodiment, the sorter module 130 performs sorting in accordance with the similarities between the current question (QNow) and the history questions (Q1, Q2, . . . , QN) and determine whether the similarities between the current question (QNow) and the history questions (Q1, Q2, . . . , QN) are 100% or substantially the same. When the sorter module 130 determines that the similarities between the current question (QNow) and some history questions (such as: Q1 and QN) are 100% or substantially the same, the history questions (such as: Q1 and QN) and the history responses (such as: A1 and AN) corresponding to the history questions (such as: Q1 and QN) are removed from the output data structure of the sorter module 130, or the history questions (such as: Q1 and QN) and the history responses (such as: A1 and AN) corresponding to the history questions (such as: Q1 and QN) are not stored to the output data structure of the sorter module 130. Then, the sorter module 130 outputs the sorting result from the output data structure to the prompt output sequence 231 so as to send the sorting result to the external LLM 150. Now, the data in the prompt output sequence 231 are QNOW, A5, Q2 . . . Q4, A2, and do not contain Q1, QN, A1, and AN.

In an embodiment, when the sorter module 130 determines that the similarity between the current question (QNow) and a history question (such as: Q2) is higher, and when the sorter module 130 determines that the similarity between the current question (QNow) and a history response (such as: A5) is higher, the history question (such as: Q2) and the history response (such as: A5) are arranged at a position closer to the current question (QNow) in the output data structure. When the sorter module 130 determines that the similarity between the current question (QNow) and a history question (such as: Q4) is lower, and when the sorter module 130 determines that the similarity between the current question (QNow) and a history response (such as: A2) is lower, the history question (such as: Q4) and the history response (such as: A2) are arranged at a position farther away from the current question (QNow) in the output data structure. Then, the sorter module 130 outputs the sorting result from the output data structure to the prompt output sequence 231 so as to send the sorting result to the external LLM 150. Now, the data in the prompt output sequence 231 are QNOW, A5, Q2 . . . Q4, A2, and the positions of A5 and Q2 are close to QNOW, and the positions of Q4 and A2 are far away from QNOW.

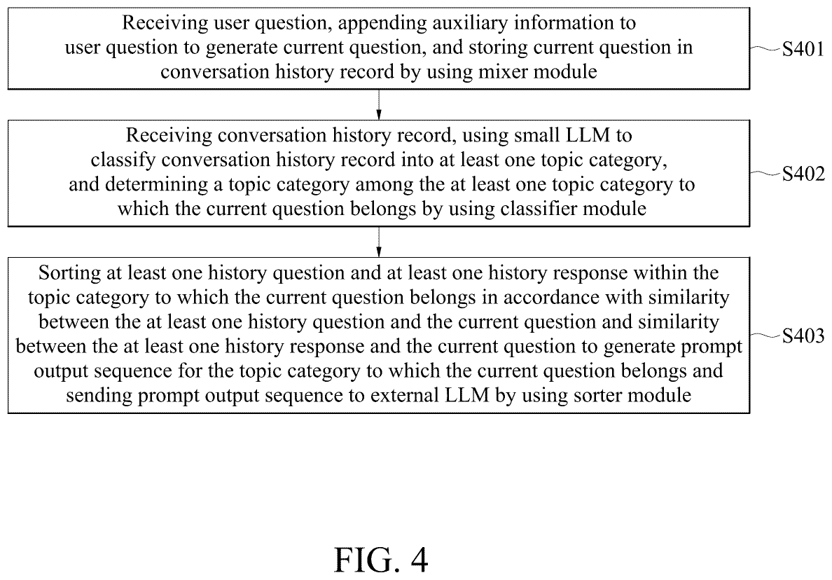

Please refer to FIG. 4. FIG. 4 illustrates a flow chart of a context management method of an edge artificial intelligence system 100 according to an embodiment of the instant disclosure. In the embodiment shown in FIG. 4, the mixer module 110 receives the user question 201 and appends auxiliary information 202 to the user question 201 to generate the current question and stores the current question in the conversation history record 211 (step S401); the classifier module 120 receives the conversation history record 211 and uses the small LLM 140 to classify the conversation history record 211 into at least one topic category 221 and determines the topic category 221 to which the current question belongs (step S402); and the sorter module 130 performs sorting on the at least one history question and the at least one history response within the topic category 221 to which the current question belongs in accordance with a similarity between the at least one history question and the current question and a similarity between the at least one history response and the current question to generate a prompt output sequence 231 for the topic category 221 to which the current question belongs and to send the prompt output sequence 231 to the external LLM 150 (step S403).

In the step S401, the auxiliary information 202 may be clock information 203, global positioning system information 204, or a sequence ID. The conversation history record 211 comprises the current question, the history questions, and the history responses.

In the step S402, the classifier module 120 comprises the tokenizer and the small LLM 140. The tokenizer divides the conversation history record 211 into a plurality of tokens for the small LLM 140 to process. The small LLM 140 comprises an embedding layer, a transformer layer, and a classification head layer. The embedding layer converts the plurality of tokens of the current question in the conversation history record 211 into an embedding vector; the transformer layer processes the embedding vector to generate a contextual meaning representation of the current question; and the classification head layer determines the topic category 221 to which the current question belongs in accordance with the contextual meaning representation of the current question.

In the step S403, the sorter module 130 obtains the similarity in accordance with a vector distance between the current question and the history question and a vector distance between the current question and the history response to determine the similarities between the current question and the history questions and the similarities between the current question and the history responses. In response to that the sorter module 130 determines that the similarities between the current question and the history questions and the similarities between the current question and the history responses are 100% or substantially the same, the history questions and the history responses are not arranged in the prompt output sequence 231. In response to that the sorter module 130 determines that the similarities between the current question and the history questions and the similarities between the current question and the history responses are higher, the history questions and the history responses are not arranged in the prompt output sequence 231. In response to that the module 130 determines that the similarities between the current question and the history questions and the similarities between the current question and the history responses are higher, the history questions and the history responses are arranged at positions closer to the current question in the prompt output sequence 231. In response to that the sorting module 130 determines that the similarities between the current question and the history questions and the similarities between the current question and the history responses are lower, the history questions and the history responses are arranged at positions farther away from the current question in the prompt output sequence 231.

Although the instant disclosure has been disclosed using the exemplary embodiments above, the exemplary embodiments are not meant to limit the instant disclosure. Any alteration and retouch made by persons skilled in the art without deviating from the spirit of the instant disclosure shall fall into the scope of the instant disclosure. The scope of protected invention shall be defined by the claims below.

What is claimed is:

1. An edge artificial intelligence system comprising:
a mixer module configured to receive a user question, to append auxiliary information to the user question to generate a current question, and to store the current question in a conversation history record;
a classifier module configured to receive the conversation history record, to use a small LLM to classify the conversation history record into at least one topic category, and to determine a topic category among the at least one topic category to which the current question belongs; and
a sorter module configured to sort at least one history question and at least one history response within the topic category to which the current question belongs in accordance with a similarity between the at least one history question and the current question and a similarity between the at least one history response and the current question to generate a prompt output sequence for the topic category to which the current question belongs and to send the prompt output sequence to an external LLM.

2. The edge artificial intelligence system according to claim 1, wherein the edge artificial intelligence system is adapted to be applied to an edge artificial intelligence device.

3. The edge artificial intelligence system according to claim 2, wherein the conversation history record is stored in a memory of the edge artificial intelligence device.

4. The edge artificial intelligence system according to claim 3, wherein the auxiliary information is clock information, global positioning system information, or a sequence mark.

5. The edge artificial intelligence system according to claim 4, wherein the classifier module comprises a tokenizer, and the tokenizer is configured to divide the conversation history record into a plurality of tokens for the small LLM to process.

6. The edge artificial intelligence system according to claim 5, wherein the small LLM comprises an embedding layer, a transformer layer, and a classification head layer, the embedding layer is configured to convert the plurality of tokens of the current question in the conversation history record into an embedding vector; the transformer layer is configured to process the embedding vector to generate a contextual meaning representation of the current question; and the classification head layer is configured to determine the topic category to which the current question belongs in accordance with the contextual meaning representation of the current question.

7. The edge artificial intelligence system according to claim 6, wherein the sorter module is configured to obtain the similarity in accordance with a vector distance between the current question and the history question and a vector distance between the current question and the history response.

8. The edge artificial intelligence system according to claim 7, wherein in response to that the sorter module determines that the similarity between the current question and the history question and the similarity between the current question and the history response are 100% or substantially the same, the sorter module does not arrange the history question and the history response into the prompt output sequence.

9. The edge artificial intelligence system according to claim 7, wherein in response to that the sorter module determines that the similarity between the current question and the history question and the similarity between the current question and the history response are higher, the sorter module arranges the history question and the history response at positions closer to the current question in the prompt output sequence.

10. The edge artificial intelligence system according to claim 7, wherein in response to that the sorter module determines that the similarity between the current question and the history question and the similarity between the current question and the history response are lower, the sorter module arranges the history question and the history response at positions farther away from the current question in the prompt output sequence.

11. A context management method of an edge artificial intelligence system, wherein the context management method comprises:
(a) receiving a user question, appending an auxiliary information to the user question to generate a current question, and storing the current question in a conversation history record by using a mixer module;
(b) receiving the conversation history record, using a small LLM to classify the conversation history record into at least one topic category, and determining a topic category among the at least one topic category to which the current question belongs by using a classifier module; and
(c) sorting at least one history question and at least one history response within the topic category to which the current question belongs in accordance with a similarity between the at least one history question and the current question and a similarity between the at least one history response and the current question to generate a prompt output sequence for the topic category to which the current question belongs and sending the prompt output sequence to an external LLM by using a sorter module.

12. The context management method of an edge artificial intelligence system according to claim 11, wherein the context management method of an edge artificial intelligence system is adapted to be applied to an edge artificial intelligence device.

13. The context management method of an edge artificial intelligence system according to claim 12, wherein the conversation history record is stored in a memory of the edge artificial intelligence device.

14. The context management method of an edge artificial intelligence system according to claim 13, wherein the auxiliary information is clock information, global positioning system information, or a sequence mark.

15. The context management method of an edge artificial intelligence system according to claim 14, wherein the step (b) comprises:
dividing the conversation history record into a plurality of tokens by using a tokenizer for the small LLM to process.

16. The context management method of an edge artificial intelligence system according to claim 15, wherein the small LLM comprises an embedding layer, a transformer layer, and a classification head layer, and the step (b) comprises:
converting the plurality of tokens of the current question in the conversation history record into an embedding vector by using the embedding layer;
processing the embedding vector by using the transformer layer to generate a contextual meaning representation of the current question; and
determining a topic category among the at least one topic category to which the current question belongs in accordance with the contextual meaning representation of the current question by using the classification head layer.

17. The context management method of an edge artificial intelligence system according to claim 16, wherein the step (c) comprises:
obtaining the similarity in accordance with a vector distance between the current question and the history question and a vector distance between the current question and the history response by using the sorter module.

18. The context management method of an edge artificial intelligence system according to claim 17, wherein the step (c) comprises:
in response to that the sorter module determines that the similarity between the current question and the history question and the similarity between the current question and the history response are 100% or substantially the same, not arranging the history question and the history response into the prompt output sequence.

19. The context management method of an edge artificial intelligence system according to claim 17, wherein the step (c) comprises:
in response to that the sorter module determines that the similarity between the current question and the history question and the similarity between the current question and the history response are higher, arranging the history question and the history response at positions closer to the current question in the prompt output sequence by using the sorter module.

20. The context management method of an edge artificial intelligence system according to claim 17, wherein the step (c) comprises:
in response to that the sorter module determines that the similarity between the current question and the history question and the similarity between the current question and the history response are lower, arranging the history question and the history response at positions farther away from the current question in the prompt output sequence by using the sorter module.
